(19) United States
(12) Patent Application Publication
(10) Pub. No.: US 2026/0228771 A1
(43) Pub. Date: Aug. 6, 2026

(54) SYSTEM FOR EVENT TICKETING USING A FLYER WITH A QR CODE AND PROMO CODE AND METHOD THEREOF

(71) Applicant: TIX.BY LLC, San Juan, PR (US)

(72) Inventor: Manuel Antonio Morales Lema, San Juan, PR (US)

(73) Assignee: TIX.BY LLC, San Juan, PR (US)

(21) Appl. No.: 19/044,168

(22) Filed: Feb. 3, 2025

(51) Int. Cl. G06Q 30/0207; G06K 19/06; G06Q 10/02; G06Q 30/0601

(52) U.S. Cl. CPC G06Q 30/0225; G06K 19/06037; G06Q 10/02; G06Q 30/0607

(57) ABSTRACT

A method and system for purchasing event tickets that utilizes a physical flyer containing a QR code and a unique promotional code. The flyer is distributed to targeted individuals, and the QR code, when scanned by a mobile device, directs the user to a virtual line hosted on a secure ticketing platform. The user inputs the promotional code printed on the flyer, which is validated against a relational database containing predefined ticket allocation limits and usage history. Upon successful validation, the user is permitted to purchase event tickets, with the system invalidating the promotional code once its usage limit is reached.

### FIELD OF THE INVENTION

The present invention relates to the field of event ticketing and, more particularly, to a system for streamlining ticket purchases through physical media featuring QR codes and promotional codes, and method thereof.

### BACKGROUND OF THE DISCLOSURE

Traditional ticket purchasing methods often require users to either physically visit a ticket center or compete with a large, global audience when purchasing online, leading to delays and logistical challenges. This can result in user dissatisfaction, long queues, and an inability to target specific local audiences. Additionally, online ticketing platforms are often exploited by automated bots that purchase large quantities of tickets before real users have a chance, leading to inflated resale prices and unfair distribution. Another issue arises when individuals from different geographic locations gain access to tickets before those in the intended local market, limiting fair access to regional attendees.

The subject disclosure addresses these challenges by combining physical media—such as flyers—with QR codes and promotional codes. This system ensures that only individuals who possess the physical flyer can access the event tickets, reducing congestion and allowing for more targeted ticket distribution. By tying ticket access to a physical flyer distributed in a specific location, the method limits or eliminates bot activity and ensures that individuals in a specific geographic area have priority access to tickets. This prevents users from other locations from purchasing tickets before those in the local market, fostering a fairer and more equitable ticketing process.

The subject disclosure provides a novel and efficient system for purchasing event tickets using a combination of physical flyers, QR codes, and promotional codes. This approach addresses the limitations of traditional ticketing methods, offering a streamlined and localized solution for event organizers and attendees alike.

### SUMMARY OF THE DISCLOSURE

The disclosure provides a system for purchasing event tickets using a flyer that includes a QR code and a promotional code, and method thereof. When the QR code is scanned by a mobile device, the user is directed to a virtual line in which tickets for the event can be purchased. The inclusion of a promo code ensures that only individuals with access to the flyer can complete the transaction. Once the promo code is exhausted, no other user can use it. This reduces the strain on traditional ticket centers and limits access to a localized audience.

The disclosed system for purchasing event tickets and method thereof has the following advantages: (1) Targeted Distribution: By using physical flyers, event organizers can limit ticket availability to a local or intended audience. (2) Queue Reduction: Virtual lines streamline the ticket purchasing process and reduce the need for physical queues at ticket centers. (3) Improved Security: The authentication of QR codes and promo codes ensures that only eligible users can access tickets. (4) Code Exhaustion Mechanism: The system prevents overuse of promo codes, ensuring fair access to tickets. (5) Enhanced User Experience: Users benefit from a faster, more convenient ticketing process.

In sum, the subject disclosure relates to a system for purchasing event tickets, comprising a physical flyer containing a QR code and a promotional code, wherein the QR code is encoded with a unique identifier generated using a cryptographic hashing mechanism to ensure data integrity and tamper resistance; a server configured to host a web-based interface or mobile application for processing ticket purchases; c. a relational database communicatively coupled to the server, wherein the relational database is structured to: i) store and manage promotional codes; ii) associate each promotional code with predefined ticket allocation limits and usage history, including maximum allowable ticket allocations, tickets already purchased, and timestamps of transactions; a queue management module configured to manage virtual lines by dynamically adjusting user positions based on predefined criteria; a secure payment gateway for processing transactions and delivering confirmation codes or digital tickets to users upon successful ticket purchase; wherein the server is configured to: i) validate a promotional code input by a user against the relational database; ii) allow ticket purchases upon successful validation of the promotional code; and iii) invalidate the promotional code within the relational database once its predefined usage limit is reached.

The subject disclosure relates to a method for purchasing event tickets comprising the steps of distributing a physical flyer containing a QR code and a promotional code, wherein the QR code is encoded with a unique identifier generated using a cryptographic hashing mechanism to ensure data integrity and tamper resistance; enabling a user to scan the QR code via a mobile device or QR code scanning application; directing the user to a virtual line through a web interface or mobile application hosted on a server; requiring the user to input the promotional code printed on the flyer into the web interface; validating the promotional code against a server-hosted relational database, wherein the database is structured to associate each promo code with predefined ticket allocation limits and usage history, including maximum allowable ticket allocations, tickets already purchased, and timestamps of transactions; allowing the user to purchase event tickets upon successful validation of the promotional code, wherein the ticketing system dynamically allocates tickets based on the predefined ticket allocation limits; invalidating the promotional code within the database once its predefined usage limit is reached, preventing further use of the code.

### BRIEF DESCRIPTION OF THE DRAWINGS

FIG. 1 shows a flowchart that illustrates the step-by-step process of the ticketing method that utilizes physical flyers containing both QR codes and promo codes.

### DETAILED DESCRIPTION OF THE DISCLOSURE

The subject disclosure relates to a system for event ticketing and method thereof that utilizes physical flyers containing both QR codes and promo codes to facilitate event ticketing in a localized and secure manner. A unique alphanumeric promo code is printed on the physical flyer and is associated with a specific event and ticket allocation in a relational database. The promo code serves as an authentication key that verifies the eligibility of the user and ensures that ticket purchases are restricted to individuals possessing the flyer. Each promo code is designed with two key parameters stored in the relational database: predefined ticket allocation limits and predefined usage limits (e.g., usage history).

The predefined ticket allocation limit refers to the maximum number of tickets that can be purchased using a specific promo code. For example, a promo code may allow a single user to purchase up to four tickets for the event. This limit ensures that users cannot exceed the allowable number of tickets per transaction. In contrast, the predefined usage limit refers to the total number of times the promo code can be used by different users. For instance, a promo code with a usage limit of five allows up to five unique individuals to use it, regardless of the number of tickets they purchase (as long as it does not exceed the ticket allocation limit). These parameters work together to control ticket distribution, ensuring both fairness and targeted access.

Each flyer also includes a QR code encoded with a unique URL or identifier. The QR code is generated using a cryptographic hashing mechanism, such as the SHA-256 algorithm (Secure Hash Algorithm 256-bit), ensuring data integrity and tamper resistance by creating a unique and verifiable hash value for the encoded URL or identifier. SHA-256 is a cryptographic hash function that generates a fixed 256-bit (32-byte) hash value from any input data, making it useful for data integrity verification, digital signatures, and cryptographic security applications. This ensures that the QR codes on the flyers cannot be altered or forged, maintaining security and trust in the ticketing system. The hashing mechanism helps verify the authenticity of the QR code and prevents unauthorized modifications or misuse. Flyers are distributed to the intended audience via mail, local businesses, or public events. The QR code, when scanned by a mobile device, redirects the user to a secure web-based interface or mobile application hosted on a server. The system is structured to provide a seamless user experience while ensuring security and localized ticket access.

The ticketing system comprises a server hosting the web-based interface or mobile application, a relational database structured to store and manage promo codes, ticket allocation limits, and usage history, and a queue management module to handle virtual lines. The relational database associates each promo code with predefined ticket allocation limits and usage history, including maximum allowable ticket allocations, tickets already purchased, and timestamps of transactions. Logs within the database track the usage history of promo codes, including user details, transaction IDs, and event-specific metadata. This ensures controlled distribution and prevents abuse by invalidating promo codes once their predefined limits are reached.

Promo codes are invalidated through a systematic process integrated into the ticketing system. When a user enters a promo code, the system validates it against the relational database. If the number of tickets purchased with the promo code reaches the predefined ticket allocation limit, the system flags the promo code as “exhausted.” This status is updated in real-time within the database, rendering the promo code invalid for further use. Additionally, any tampering attempts with the promo code or its associated data are mitigated by the cryptographic hashing mechanism, which ensures data integrity. Real-time updates within the system ensure that once a promo code is flagged as exhausted, it cannot be reused or misused, providing a secure and controlled ticketing environment.

When a user scans the QR code using a mobile device equipped with a camera or QR code scanning functionality, the device redirects them to the secure interface or platform hosted by the server. On this interface or platform, the user is prompted to input the promo code printed on the flyer. The promo code is validated against the relational database to ensure it is eligible for use. Specifically, the ticketing system queries the relational database to validate the promo code based on one or more of the following steps: (1) Existence Check: the database verifies whether the entered promo code exists and is active; (2) Limit Check: the system ensures that the promo code has not exceeded its predefined ticket allocation limit or predefined usage limit; (3) Tamper Resistance: the unique identifier embedded in the QR code and promo code undergoes cryptographic hashing verification to confirm that it hasn't been tampered with; and (4) Eligibility Check: additional criteria such as event-specific metadata or location restrictions may also be evaluated.

If validation is successful, the user is placed in a virtual queue managed by the queue management module. This module dynamically adjusts user positions based on predefined criteria such as time of access, user engagement, and transaction completion. User engagement may include active interactions with the platform, such as confirming readiness, responding to notifications, or completing transactions promptly. Users receive real-time updates on their position in line, estimated wait times, and ticket availability.

When the user's turn arrives, they gain access to purchase tickets for the event. They select the desired number of tickets, subject to availability and the limits set by the event organizer. Transactions are finalized through a secure payment gateway that employs token-based authentication for enhanced security. Upon successful payment, the system generates unique digital tickets or confirmation codes, which are delivered to the user via email or SMS. These tickets can be redeemed at the event venue or printed if necessary.

The ticketing system also incorporates analytics tools, enabling event organizers to track ticket purchases and user engagement, providing insights into the geographic distribution and behavior of ticket buyers. By limiting ticket access to individuals who possess the physical flyer, the invention ensures targeted distribution, reduces server load, and mitigates issues associated with global online ticketing. The ticketing system is specifically designed to provide a scalable, efficient, and user-friendly platform for event organizers and attendees alike.

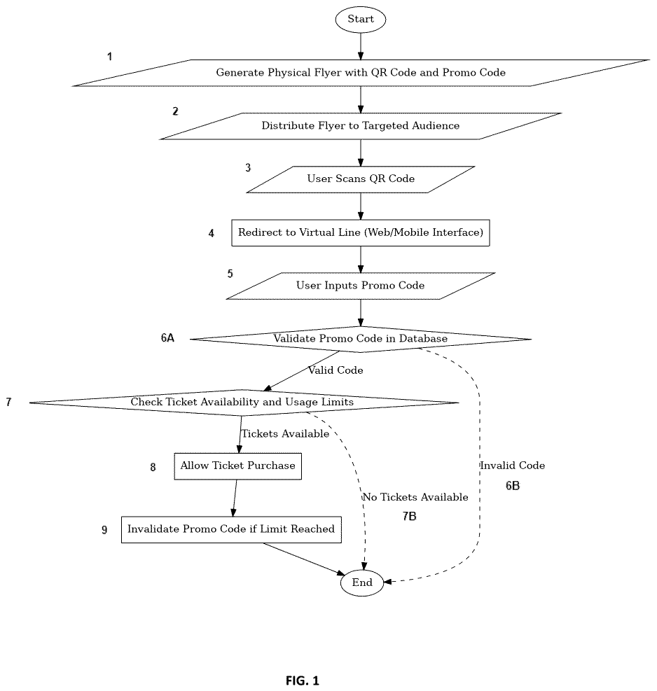

FIG. 1 shows a flowchart that illustrates the step-by-step process of the ticketing method, ensuring structured execution and logical flow. The process begins, at step 1, with generating a physical flyer that contains a QR code and a unique promotional code. Once the flyer is created, it is distributed, at step 2, to targeted individuals. When a user receives the flyer, they scan the QR code, at step 3, using a mobile device, which redirects them, at step 4, to a virtual line hosted on a web-based interface or mobile application. Upon arrival at the platform, the user is prompted, at step 5, to input the promotional code printed on the flyer.

Once the promo code is entered, the system validates it, at step 6A, against a relational database that stores ticket allocation limits and usage history. If the code is valid, the system proceeds, at step 7A, to check whether tickets are still available and whether the predefined ticket allocation limit for that code has been reached. If tickets are available, the user is granted access, at step 8, to purchase event tickets. After a successful transaction, the system dynamically updates the database and invalidates the promo code, at step 9, once its predefined usage limit is exhausted, preventing further use of the code.

As also shown in FIG. 1, if the promo code is invalid or has already been exhausted, the system, at step 6B, terminates the process, denying ticket access. Similarly, if no tickets remain available, the user is informed at step 7B, and the process ends. This structured approach ensures secure and localized ticket distribution, prevents automated bot exploitation, and maintains fair access for users within the targeted geographic area. This structured approach ensures a controlled, efficient, and secure ticketing process while preventing unauthorized access.

In sum, the present disclosure provides a novel and efficient method and system for event ticketing using a physical flyer embedded with a QR code and a unique promotional code. By integrating cryptographic hashing for data integrity, a relational database for ticket allocation management, and a virtual queue system for structured access, this subject disclosure ensures a secure, fair, and localized ticket distribution process. The approach effectively mitigates issues associated with traditional online ticketing systems, such as automated bot exploitation and unfair ticket distribution to users outside the intended geographic area.

By requiring users to physically possess a flyer to access ticket purchases, the ticketing system enhances exclusivity and control over ticket distribution while reducing server congestion. Additionally, the automated validation and real-time tracking of promotional codes prevent unauthorized reuse and enable dynamic ticket management. The incorporation of user engagement metrics and a queue management module further optimizes the ticketing experience, ensuring that only eligible individuals gain access to event tickets.

Through this innovative approach, event organizers can streamline their ticketing operations, improve security, and enhance user satisfaction while maintaining a fair distribution model. The described system and method offer a scalable and technologically advanced solution that can be applied across various event types, ensuring accessibility and efficiency in ticket sales.

1. A tamper-resistant, access-controlled electronic ticketing system, comprising:
a non-transitory physical flyer containing a machine-readable QR code and a human-readable promotional code, the QR code encoding a unique identifier generated by a cryptographic hash function to provide tamper-resistant verification of the unique identifier;
a network-connected server that hosts a transactional web-based interface or mobile application for processing ticket purchases;
a relational database communicatively coupled to the server and persistently storing for each promotional code, a predefined ticket allocation limit, a predefined usage limit, and time-stamped usage history;
a server-executed queue-management engine configured to condition purchase authorization on dynamically advancing users into an authorization state based on predefined server-enforced criteria;
a secure payment gateway confirmation integrated with the server to process transactions and deliver confirmation codes or digitally signed tickets upon successful purchase;
wherein the server is configured to:
i. verify the QR code by recomputing the cryptographic hash of the unique identifier to detect tampering prior to accepting the promotional code;
ii. validate a promotional code received from a user against the relational database;
iii. authorize a ticket purchase only when the queue-management engine places the user in the authorization state and the promotional code remains within its ticket-allocation and usage limits; and
iv. update the relational database in real time to invalidate the promotional code once its predefined usage limit is reached, thereby preventing reuse of the promotional code.

2. The system of claim 1, wherein the cryptographic hash function comprises SHA-256, and the server verifies integrity by recomputing the hash from the unique identifier before enabling acceptance of the promotional code.

3. The system of claim 1, wherein the server performs invalidation of the promotional code as part of a real-time update that prevents reuse of the promotional code once its predefined usage limit is reached.

4. The system of claim 1, wherein the queue-management engine exposes an authorization state that is required before enabling the secure payment gateway, thereby mitigating automated bot activity by throttling access to the purchase workflow.

5. The system of claim 1, wherein the server is further configured to present real-time queue status information to the user, including updated position in line and estimated wait time, based on dynamic adjustments performed by the queue-management engine.

6. The system of claim 1, wherein the relational database stores transaction-specific metadata associated with each validated promotional code, including user identifiers, transaction timestamps, and event-specific parameters.

7. The system of claim 1, wherein the server is further configured to transmit confirmation codes or digital tickets to the user via at least one secure communication channel selected from email and SMS upon successful completion of payment.

8. A method for purchasing event tickets in a tamper-resistant, access-controlled electronic ticketing system:
distributing a non-transitory physical flyer containing a machine-readable QR code and a human-readable promotional code, the QR code encoding a unique identifier generated by a cryptographic hash function to provide tamper-resistant verification of the identifier;
enabling a user to scan the QR code using a mobile device or QR-code scanning application;
directing the user, in response to the scan, to a virtual line through a transactional web-based interface or mobile application hosted on a network-connected server;
requiring the user to input the promotional code printed on the flyer into the web interface;
verifying the QR code by recomputing the cryptographic hash of the unique identifier to detect tampering before accepting the promotional code;
validating the promotional code against a server-hosted relational database persistently storing, for each promotional code, a predefined ticket-allocation limit, a predefined usage limit, and time-stamped usage history.
advancing the user into an authorization state using a server-executed queue-management engine configured to condition purchase authorization based on predefined, server-enforced criteria;
allowing the user to purchase event tickets only when the promotional code is successfully validated and the user has been placed into the authorization state;
updating the relational database in real time to invalidate the promotional code once its predefined usage limit is reached, thereby preventing further use of the promotional code.

9. The method of claim 8, wherein the cryptographic hash function comprises SHA-256, and verifying the QR code includes recomputing a SHA-256 hash of the unique identifier prior to accepting the promotional code.

10. The method of claim 8, further comprising performing a real-time database update that, upon determining that the predefined usage limit for the promotional code has been reached, invalidates the promotional code to prevent reuse.

11. The method of claim 8, further comprising conditioning access to payment by requiring that a server-executed queue-management engine place the user into an authorization state before enabling a payment workflow, thereby mitigating automated bot activity.

12. The method of claim 8, further comprising presenting to the user real-time queue status information, including an updated position in line and an estimated wait time, based on dynamic adjustments performed by the server-executed queue-management engine.

13. The method of claim 8, further comprising storing, in the relational database, transaction-specific metadata for each validated promotional code, including user identifiers, transaction timestamps, and event-specific parameters.

14. The method of claim 8, further comprising transmitting, upon successful completion of payment, a confirmation code or digital ticket to the user via at least one secure communication channel selected from email and SMS.

15. The system of claim 1, wherein the predefined server-enforced criteria comprise one or more of:
(a) a time-of-access ordering established by the server;
(b) successful cryptographic integrity verification of the QR-encoded unique identifier prior to accepting a promotional code;
(c) validation that the promotional code remains within a predefined ticket-allocation limit and a predefined usage limit recorded with time-stamped history in the relational database;
(d) satisfaction of queue-related user-engagement conditions used by the server to advance a user in the virtual line; and
(e) confirmation that payment processing prerequisites have been met for the secure payment workflow.

16. The method of claim 8, wherein the predefined server-enforced criteria comprise one or more of:
(a) ordering users by server-determined time of access;
(b) verifying the QR code by recomputing a cryptographic hash of the unique identifier before accepting the promotional code;
(c) confirming, via the relational database, that the promotional code is within a predefined ticket-allocation limit and a predefined usage limit recorded with time-stamped usage history;
(d) determining that queue-related user-engagement conditions are satisfied for advancement into the authorization state; and
(e) confirming that payment processing prerequisites are satisfied for the secure payment workflow.
